(19) United States
(12) Patent Application Publication
(10) Pub. No.: US 2016/0171610 A1
(43) Pub. Date: Jun. 16, 2016

(54) METHODS AND APPARATUS TO MANAGE TRADING STRATEGIES

(71) Applicant: TRADING TECHNOLOGIES INTERNATIONAL INC., CHICAGO, IL (US)

(72) Inventor: Brian Haag, Denver, CO (US)

(21) Appl. No.: 14/572,481

(22) Filed: Dec. 16, 2014

(51) Int. Cl. G06Q 40/06

(52) U.S. Cl. CPC G06Q 40/06; G06Q 40/04

(57) ABSTRACT

Methods and apparatus to manage trading strategies are disclosed. An example method includes defining a trading strategy having a first leg associated with a first tradeable object and a second leg associated with a second tradeable object, wherein the first and second tradeable objects are listed on an electronic exchange; defining a quoting behavior rule for the trading strategy based on at least one of a first liquidity associated with the first leg or a second liquidity associated with the second leg; and determining whether to re-quote the trading strategy based on market activity and the quoting behavior rule.

### BACKGROUND

An electronic trading system generally includes a trading device in communication with an electronic exchange. The trading device receives information about a market, such as prices and quantities, from the electronic exchange. The electronic exchange receives messages, such as messages related to orders, from the trading device. The electronic exchange attempts to match quantity of an order with quantity of one or more contra-side orders.

In addition to trading single items, a user may trade more than one item according to a trading strategy. One common trading strategy is a spread and trading according to a trading strategy may also be referred to as spread trading. Spread trading may attempt to capitalize on changes or movements in the relationships between the items in the trading strategy, for example.

### BRIEF DESCRIPTION OF THE FIGURES

Certain embodiments are disclosed with reference to the following drawings.

FIG. 1 illustrates a block diagram representative of an example electronic trading system in which certain embodiments may be employed.

FIG. 2 illustrates a block diagram of another example electronic trading system in which certain embodiments may be employed.

FIG. 3 illustrates a block diagram of an example computing device which may be used to implement the disclosed embodiments.

FIG. 4 illustrates a block diagram of a trading strategy, which may be employed with certain disclosed embodiments.

FIG. 5 is a flowchart representative of example machine readable instructions that may be executed to implement disclosed embodiments.

FIG. 6 is a flowchart representative of example machine readable instructions that may be executed to implement disclosed embodiments.

FIG. 7 is a flowchart representative of example machine readable instructions that may be executed to implement disclosed embodiments.

FIG. 8 is a flowchart representative of example machine readable instructions that may be executed to implement disclosed embodiments.

FIG. 9 is a block diagram representative of an example quoting behavior management module that can implement the example machine readable instructions of FIGS. 5, 6, 7, and/or 8.

Certain embodiments will be better understood when read in conjunction with the provided figures, which illustrate examples. It should be understood, however, that the embodiments are not limited to the arrangements and instrumentality shown in the attached figures.

### DETAILED DESCRIPTION

The disclosed embodiments related to trading strategies and, more particularly, to methods and apparatus to manage trading strategies.

Some trading strategies include one more parameters or settings that are dynamically adjustable. For example, a quantity or price of one or more legs of a spread can be adjusted in response to a change in market conditions such as a change in available quantity of a tradeable object. These adjustments typically cause a corresponding user to incur fees. Additionally or alternatively, the user may be subject to restrictions on such adjustments imposed by, for example, an exchange. For example, an exchange may require the user to receive at least one fill for every twenty quoting orders placed (or adjustments made those orders) or be subject to having orders rejected or assessed a fee. Therefore, in some instances, frequent adjustments to a trading strategy lead to excessive fees and/or other types of undesirable outcomes. Moreover, some adjustments to a trading strategy, such as a cancellation of an order, cause the user to lose a previously held position in a queue at the exchange. In other words, adjustments can result in the corresponding order being placed at an end of the queue, thereby reducing a likelihood of having the order filled as desired.

Embodiments disclosed herein recognize that dynamically adjustable trading strategies are sometimes adjusted at an unnecessarily and/or undesirably high frequency. Embodiments disclosed herein provide greater control than known systems over when adjustments are made to one or more parameters of dynamically adjustable trading strategies. Embodiments disclosed herein recognize that a first event (for example, a change in price in a leg of the trading strategy, a change in quantity in a leg of the trading strategy, etc.) occurring in a first market may be more significant and/or meaningful (for example, according to a user of a trading strategy) than a second event (for example, a change in price in a leg of the trading strategy, a change in quantity in a leg of the trading strategy, etc.) occurring in a second market different than the first market. Put another way, embodiments disclosed herein recognize that, while the first event of the first market justifies or warrants (for example, according to the user of the trading strategy) an adjustment of the trading strategy, the second event of the second market may not justify or warrant an adjustment of the trading strategy. As such, embodiments disclosed herein enable configuration of a dynamic trading strategy in which a market event may or may not trigger an adjustment to the trading strategy depending on, for example, one more aspects of one or more markets involving in the trading strategy.

For example, embodiments disclosed herein enable one or more liquidity factors associated with one or more markets to dictate whether a particular market event triggers an adjustment to the corresponding trading strategy. Thus, for trading strategies involving multiple markets, such as a spread having one or more legs in different markets, embodiments disclosed herein enable a first event detected in a first market of a first leg to trigger adjustment(s) and a second event detected in a second market of a second leg to not trigger an adjustment. In some examples, the first market is designated as governing the adjustment of the trading strategy. The designation of which market (or leg) as governing the trading strategy adjustment is based on, for example, the respective liquidity factors of the markets. In the above example, the first market is designated as governing the trading strategy adjustment due to the first market typically having less activity than the second market. That is, embodiments disclosed herein enable the designation of one or more markets as controlling when and/or how adjustment(s) are made based on the comparative liquidity of the individual markets involving in the trading strategy. Often, activity or events in an illiquid market are more meaningful and/or significant to a trading strategy such as a spread than activity or events in a liquid market. Accordingly, the governing of the trading strategy adjustment(s) based on the liquidity factors of the markets, as provided by the present disclosure, reduces the occurrence of less meaningful or expensive adjustments to trading strategies, thereby maintaining queue position and/or avoiding additional fees.

Although this description discloses embodiments including, among other components, software executed on hardware, it should be noted that the embodiments are merely illustrative and should not be considered as limiting. For example, it is contemplated that any or all of these hardware and software components may be embodied exclusively in hardware, exclusively in software, exclusively in firmware, or in any combination of hardware, software, and/or firmware. Accordingly, certain embodiments may be implemented in other ways.

### I. Brief Description of Certain Embodiments

An example disclosed method includes defining a trading strategy having a first leg associated with a first tradeable object and a second leg associated with a second tradeable object, wherein the first and second tradeable objects are listed on an electronic exchange; defining a quoting behavior rule for the trading strategy based on at least one of a first liquidity associated with the first leg or a second liquidity associated with the second leg; and determining whether to re-quote the trading strategy based on market activity and the quoting behavior rule.

An example disclosed tangible computer readable medium comprises instructions that, when executed, cause a machine to at least define a trading strategy having a first leg associated with a first tradeable object and a second leg associated with a second tradeable object, wherein the first and second tradeable objects are listed on an electronic exchange; define a quoting behavior rule for the trading strategy based on at least one of a first liquidity associated with the first leg or a second liquidity associated with the second leg; and determine whether to re-quote the trading strategy based on market activity and the quoting behavior rule.

An example disclosed apparatus includes an application to define a trading strategy having a first leg associated with a first tradeable object and a second leg associated with a second tradeable object, wherein the first and second tradeable objects are listed on an electronic exchange; a quoting behavior management module to define a quoting behavior rule for the trading strategy based on at least one of a first liquidity associated with the first leg or a second liquidity associated with the second leg, and determine whether to re-quote the trading strategy based on market activity and the quoting behavior rule, wherein at least one of the application or the quoting behavior management module is implemented via a processor.

### II. Example Electronic Trading System

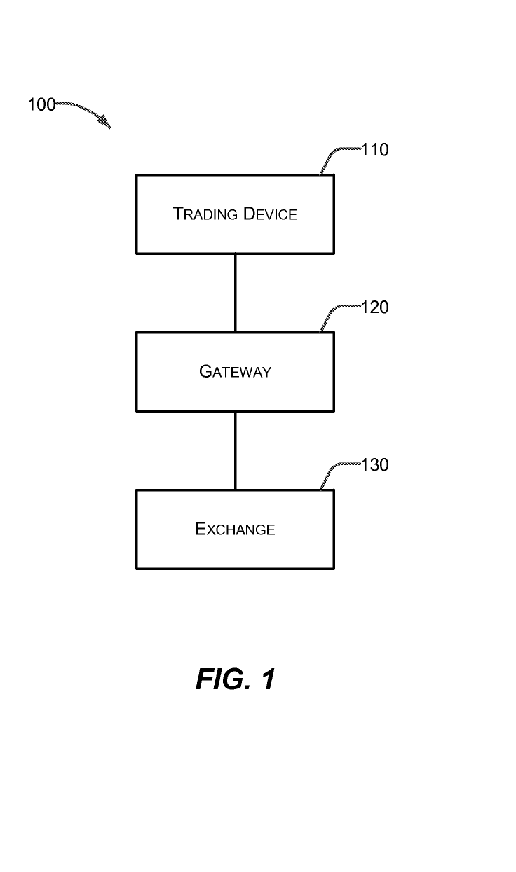

FIG. 1 illustrates a block diagram representative of an example electronic trading system 100 in which certain embodiments may be employed. The system 100 includes a trading device 110, a gateway 120, and an exchange 130. The trading device 110 is in communication with the gateway 120. The gateway 120 is in communication with the exchange 130. As used herein, the phrase “in communication with” encompasses direct communication and/or indirect communication through one or more intermediary components. The exemplary electronic trading system 100 depicted in FIG. 1 may be in communication with additional components, subsystems, and elements to provide additional functionality and capabilities without departing from the teaching and disclosure provided herein.

In operation, the trading device 110 may receive market data from the exchange 130 through the gateway 120. A user may utilize the trading device 110 to monitor this market data and/or base a decision to send an order message to buy or sell one or more tradeable objects to the exchange 130.

Market data may include data about a market for a tradeable object. For example, market data may include the inside market, market depth, last traded price (“LTP”), a last traded quantity (“LTQ”), or a combination thereof. The inside market refers to the highest available bid price (best bid) and the lowest available ask price (best ask or best offer) in the market for the tradeable object at a particular point in time (since the inside market may vary over time). Market depth refers to quantities available at price levels including the inside market and away from the inside market. Market depth may have “gaps” due to prices with no quantity based on orders in the market.

The price levels associated with the inside market and market depth can be provided as value levels which can encompass prices as well as derived and/or calculated representations of value. For example, value levels may be displayed as net change from an opening price. As another example, value levels may be provided as a value calculated from prices in two other markets. In another example, value levels may include consolidated price levels.

A tradeable object is anything which may be traded. For example, a certain quantity of the tradeable object may be bought or sold for a particular price. A tradeable object may include, for example, financial products, stocks, options, bonds, future contracts, currency, warrants, funds derivatives, securities, commodities, swaps, interest rate products, index-based products, traded events, goods, or a combination thereof. A tradeable object may include a product listed and/or administered by an exchange, a product defined by the user, a combination of real or synthetic products, or a combination thereof. There may be a synthetic tradeable object that corresponds and/or is similar to a real tradeable object.

An order message is a message that includes a trade order. A trade order may be, for example, a command to place an order to buy or sell a tradeable object; a command to initiate managing orders according to a defined trading strategy; a command to change, modify, or cancel an order; an instruction to an electronic exchange relating to an order; or a combination thereof.

The trading device 110 may include one or more electronic computing platforms. For example, the trading device 110 may include a desktop computer, hand-held device, laptop, server, a portable computing device, a trading terminal, an embedded trading system, a workstation, an algorithmic trading system such as a “black box” or “grey box” system, cluster of computers, or a combination thereof. As another example, the trading device 110 may include a single or multi-core processor in communication with a memory or other storage medium configured to accessibly store one or more computer programs, applications, libraries, computer readable instructions, and the like, for execution by the processor.

As used herein, the phrases “configured to” and “adapted to” encompass that an element, structure, or device has been modified, arranged, changed, or varied to perform a specific function or for a specific purpose.

By way of example, the trading device 110 may be implemented as a personal computer running a copy of X_TRADER®, an electronic trading platform provided by Trading Technologies International, Inc. of Chicago, Ill. (“Trading Technologies”). As another example, the trading device 110 may be a server running a trading application providing automated trading tools such as ADL®, AUTOSPREADER®, and/or AUTOTRADER™, also provided by Trading Technologies. In yet another example, the trading device 110 may include a trading terminal in communication with a server, where collectively the trading terminal and the server are the trading device 110.

The trading device 110 is generally owned, operated, controlled, programmed, configured, or otherwise used by a user. As used herein, the phrase “user” may include, but is not limited to, a human (for example, a trader), trading group (for example, a group of traders), or an electronic trading device (for example, an algorithmic trading system). One or more users may be involved in the ownership, operation, control, programming, configuration, or other use, for example.

The trading device 110 may include one or more trading applications. As used herein, a trading application is an application that facilitates or improves electronic trading. A trading application provides one or more electronic trading tools. For example, a trading application stored by a trading device may be executed to arrange and display market data in one or more trading windows. In another example, a trading application may include an automated spread trading application providing spread trading tools. In yet another example, a trading application may include an algorithmic trading application that automatically processes an algorithm and performs certain actions, such as placing an order, modifying an existing order, deleting an order. In yet another example, a trading application may provide one or more trading screens. A trading screen may provide one or more trading tools that allow interaction with one or more markets. For example, a trading tool may allow a user to obtain and view market data, set order entry parameters, submit order messages to an exchange, deploy trading algorithms, and/or monitor positions while implementing various trading strategies. The electronic trading tools provided by the trading application may always be available or may be available only in certain configurations or operating modes of the trading application.

A trading application may be implemented utilizing computer readable instructions that are stored in a computer readable medium and executable by a processor. A computer readable medium may include various types of volatile and non-volatile storage media, including, for example, random access memory, read-only memory, programmable read-only memory, electrically programmable read-only memory, electrically erasable read-only memory, flash memory, any combination thereof, or any other tangible data storage device. As used herein, the term non-transitory or tangible computer readable medium is expressly defined to include any type of computer readable storage media and to exclude propagating signals.

One or more components or modules of a trading application may be loaded into the computer readable medium of the trading device 110 from another computer readable medium. For example, the trading application (or updates to the trading application) may be stored by a manufacturer, developer, or publisher on one or more CDs or DVDs, which are then loaded onto the trading device 110 or to a server from which the trading device 110 retrieves the trading application. As another example, the trading device 110 may receive the trading application (or updates to the trading application) from a server, for example, via the Internet or an internal network. The trading device 110 may receive the trading application or updates when requested by the trading device 110 (for example, “pull distribution”) and/or un-requested by the trading device 110 (for example, “push distribution”).

The trading device 110 may be adapted to send order messages. For example, the order messages may be sent to through the gateway 120 to the exchange 130. As another example, the trading device 110 may be adapted to send order messages to a simulated exchange in a simulation environment which does not effectuate real-world trades.

The order messages may be sent at the request of a user. For example, a trader may utilize the trading device 110 to send an order message or manually input one or more parameters for a trade order (for example, an order price and/or quantity). As another example, an automated trading tool provided by a trading application may calculate one or more parameters for a trade order and automatically send the order message. In some instances, an automated trading tool may prepare the order message to be sent but not actually send it without confirmation from a user.

An order message may be sent in one or more data packets or through a shared memory system. For example, an order message may be sent from the trading device 110 to the exchange 130 through the gateway 120. The trading device 110 may communicate with the gateway 120 using a local area network, a wide area network, a wireless network, a virtual private network, a cellular network, a peer-to-peer network, a T1 line, a T3 line, an integrated services digital network (“ISDN”) line, a point-of-presence, the Internet, a shared memory system and/or a proprietary network such as TTNET™ provided by Trading Technologies, for example.

The gateway 120 may include one or more electronic computing platforms. For example, the gateway 120 may be implemented as one or more desktop computer, hand-held device, laptop, server, a portable computing device, a trading terminal, an embedded trading system, workstation with a single or multi-core processor, an algorithmic trading system such as a “black box” or “grey box” system, cluster of computers, or any combination thereof.

The gateway 120 may facilitate communication. For example, the gateway 120 may perform protocol translation for data communicated between the trading device 110 and the exchange 130. The gateway 120 may process an order message received from the trading device 110 into a data format understood by the exchange 130, for example. Similarly, the gateway 120 may transform market data in an exchange-specific format received from the exchange 130 into a format understood by the trading device 110, for example.

The gateway 120 may include a trading application, similar to the trading applications discussed above, that facilitates or improves electronic trading. For example, the gateway 120 may include a trading application that tracks orders from the trading device 110 and updates the status of the order based on fill confirmations received from the exchange 130. As another example, the gateway 120 may include a trading application that coalesces market data from the exchange 130 and provides it to the trading device 110. In yet another example, the gateway 120 may include a trading application that provides risk processing, calculates implieds, handles order processing, handles market data processing, or a combination thereof.

In certain embodiments, the gateway 120 communicates with the exchange 130 using a local area network, a wide area network, a wireless network, a virtual private network, a cellular network, a peer-to-peer network, a T1 line, a T3 line, an ISDN line, a point-of-presence, the Internet, a shared memory system, and/or a proprietary network such as TTNET™ provided by Trading Technologies, for example.

The exchange 130 may be owned, operated, controlled, or used by an exchange entity. Example exchange entities include the CME Group, the London International Financial Futures and Options Exchange, the Intercontinental Exchange, and Eurex. The exchange 130 may include an electronic matching system, such as a computer, server, or other computing device, which is adapted to allow tradeable objects, for example, offered for trading by the exchange, to be bought and sold. The exchange 130 may include separate entities, some of which list and/or administer tradeable objects and others which receive and match orders, for example. The exchange 130 may include an electronic communication network (“ECN”), for example.

The exchange 130 may be an electronic exchange. The exchange 130 is adapted to receive order messages and match contra-side trade orders to buy and sell tradeable objects. Unmatched trade orders may be listed for trading by the exchange 130. Once an order to buy or sell a tradeable object is received and confirmed by the exchange, the order is considered to be a working order until it is filled or cancelled. If only a portion of the quantity of the order is matched, then the partially filled order remains a working order. The trade orders may include trade orders received from the trading device 110 or other devices in communication with the exchange 130, for example. For example, typically the exchange 130 will be in communication with a variety of other trading devices (which may be similar to trading device 110) which also provide trade orders to be matched.

The exchange 130 is adapted to provide market data. Market data may be provided in one or more messages or data packets or through a shared memory system. For example, the exchange 130 may publish a data feed to subscribing devices, such as the trading device 110 or gateway 120. The data feed may include market data.

The system 100 may include additional, different, or fewer components. For example, the system 100 may include multiple trading devices, gateways, and/or exchanges. In another example, the system 100 may include other communication devices, such as middleware, firewalls, hubs, switches, routers, servers, exchange-specific communication equipment, modems, security managers, and/or encryption/decryption devices.

### III. Expanded Example Electronic Trading System

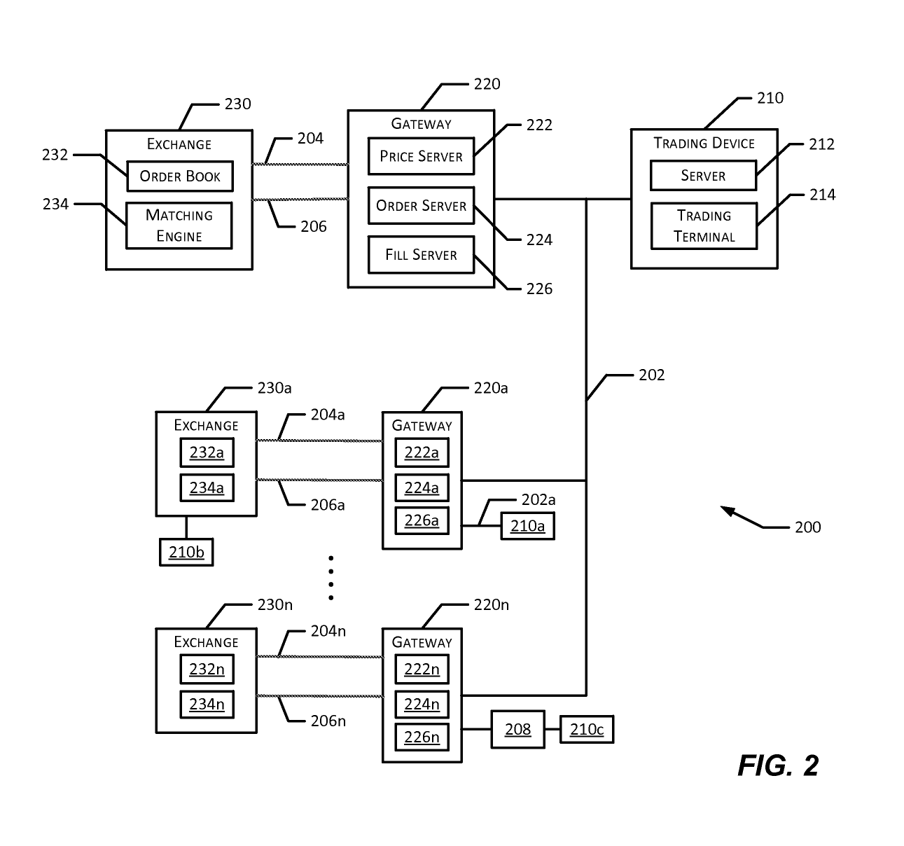

FIG. 2 illustrates a block diagram of another example electronic trading system 200 in which certain embodiments may be employed. In this example, a trading device 210 may utilize one or more communication networks to communicate with a gateway 220 and exchange 230. For example, the trading device 210 utilizes network 202 to communicate with the gateway 220, and the gateway 220, in turn, utilizes the networks 204 and 206 to communicate with the exchange 230. As used herein, a network facilitates or enables communication between computing devices such as the trading device 210, the gateway 220, and the exchange 230.

The following discussion generally focuses on the trading device 210, gateway 220, and the exchange 230. However, the trading device 210 may also be connected to and communicate with “n” additional gateways (individually identified as gateways 220a-220n, which may be similar to gateway 220) and “n” additional exchanges (individually identified as exchanges 230a-230n, which may be similar to exchange 230) by way of the network 202 (or other similar networks). Additional networks (individually identified as networks 204a-204n and 206a-206n, which may be similar to networks 204 and 206, respectively) may be utilized for communications between the additional gateways and exchanges. The communication between the trading device 210 and each of the additional exchanges 230a-230n need not be the same as the communication between the trading device 210 and exchange 230. Generally, each exchange has its own preferred techniques and/or formats for communicating with a trading device, a gateway, the user, or another exchange. It should be understood that there is not necessarily a one-to-one mapping between gateways 220a-220n and exchanges 230a-230n. For example, a particular gateway may be in communication with more than one exchange. As another example, more than one gateway may be in communication with the same exchange. Such an arrangement may, for example, allow one or more trading devices 210 to trade at more than one exchange (and/or provide redundant connections to multiple exchanges).

Additional trading devices 210a-210n, which may be similar to trading device 210, may be connected to one or more of the gateways 220a-220n and exchanges 230a-230n. For example, the trading device 210a may communicate with the exchange 230a via the gateway 220a and the networks 202a, 204a and 206a. In another example, the trading device 210b may be in direct communication with exchange 230a. In another example, trading device 210c may be in communication with the gateway 220n via an intermediate device 208 such as a proxy, remote host, or WAN router.

The trading device 210, which may be similar to the trading device 110 in FIG. 1, includes a server 212 in communication with a trading terminal 214. The server 212 may be located geographically closer to the gateway 220 than the trading terminal 214 in order to reduce latency. In operation, the trading terminal 214 may provide a trading screen to a user and communicate commands to the server 212 for further processing. For example, a trading algorithm may be deployed to the server 212 for execution based on market data. The server 212 may execute the trading algorithm without further input from the user. In another example, the server 212 may include a trading application providing automated trading tools and communicate back to the trading terminal 214. The trading device 210 may include additional, different, or fewer components.

In operation, the network 202 may be a multicast network configured to allow the trading device 210 to communicate with the gateway 220. Data on the network 202 may be logically separated by subject such as, for example, by prices, orders, or fills. As a result, the server 212 and trading terminal 214 can subscribe to and receive data such as, for example, data relating to prices, orders, or fills, depending on their individual needs.

The gateway 220, which may be similar to the gateway 120 of FIG. 1, may include a price server 222, order server 224, and fill server 226. The gateway 220 may include additional, different, or fewer components. The price server 222 may process price data. Price data includes data related to a market for one or more tradeable objects. The order server 224 processes order data. Order data is data related to a user's trade orders. For example, order data may include order messages, confirmation messages, or other types of messages. The fill server collects and provides fill data. Fill data includes data relating to one or more fills of trade orders. For example, the fill server 226 may provide a record of trade orders, which have been routed through the order server 224, that have and have not been filled. The servers 222, 224, and 226 may run on the same machine or separate machines. There may be more than one instance of the price server 222, the order server 224, and/or the fill server 226 for gateway 220. In certain embodiments, the additional gateways 220a-220n may each includes instances of the servers 222, 224, and 226 (individually identified as servers 222a-222n, 224a-224n, and 226a-226n).

The gateway 220 may communicate with the exchange 230 using one or more communication networks. For example, as shown in FIG. 2, there may be two communication networks connecting the gateway 220 and the exchange 230. The network 204 may be used to communicate market data to the price server 222. In some instances, the exchange 230 may include this data in a data feed that is published to subscribing devices. The network 206 may be used to communicate order data to the order server 224 and the fill server 226. The network 206 may also be used to communicate order data from the order server 224 to the exchange 230.

The exchange 230, which may be similar to the exchange 130 of FIG. 1, includes an order book 232 and a matching engine 234. The exchange 230 may include additional, different, or fewer components. The order book 232 is a database that includes data relating to unmatched trade orders that have been submitted to the exchange 230. For example, the order book 232 may include data relating to a market for a tradeable object, such as the inside market, market depth at various price levels, the last traded price, and the last traded quantity. The matching engine 234 may match contra-side bids and offers pending in the order book 232. For example, the matching engine 234 may execute one or more matching algorithms that match contra-side bids and offers. A sell order is contra-side to a buy order. Similarly, a buy order is contra-side to a sell order. A matching algorithm may match contra-side bids and offers at the same price, for example. In certain embodiments, the additional exchanges 230a-230n may each include order books and matching engines (individually identified as the order book 232a-232n and the matching engine 234a-234n, which may be similar to the order book 232 and the matching engine 234, respectively). Different exchanges may use different data structures and algorithms for tracking data related to orders and matching orders.

In operation, the exchange 230 may provide price data from the order book 232 to the price server 222 and order data and/or fill data from the matching engine 234 to the order server 224 and/or the fill server 226. Servers 222, 224, 226 may process and communicate this data to the trading device 210. The trading device 210, for example, using a trading application, may process this data. For example, the data may be displayed to a user. In another example, the data may be utilized in a trading algorithm to determine whether a trade order should be submitted to the exchange 230. The trading device 210 may prepare and send an order message to the exchange 230.

In certain embodiments, the gateway 220 is part of the trading device 210. For example, the components of the gateway 220 may be part of the same computing platform as the trading device 210. As another example, the functionality of the gateway 220 may be performed by components of the trading device 210. In certain embodiments, the gateway 220 is not present. Such an arrangement may occur when the trading device 210 does not need to utilize the gateway 220 to communicate with the exchange 230, such as if the trading device 210 has been adapted to communicate directly with the exchange 230.

### IV. Example Computing Device

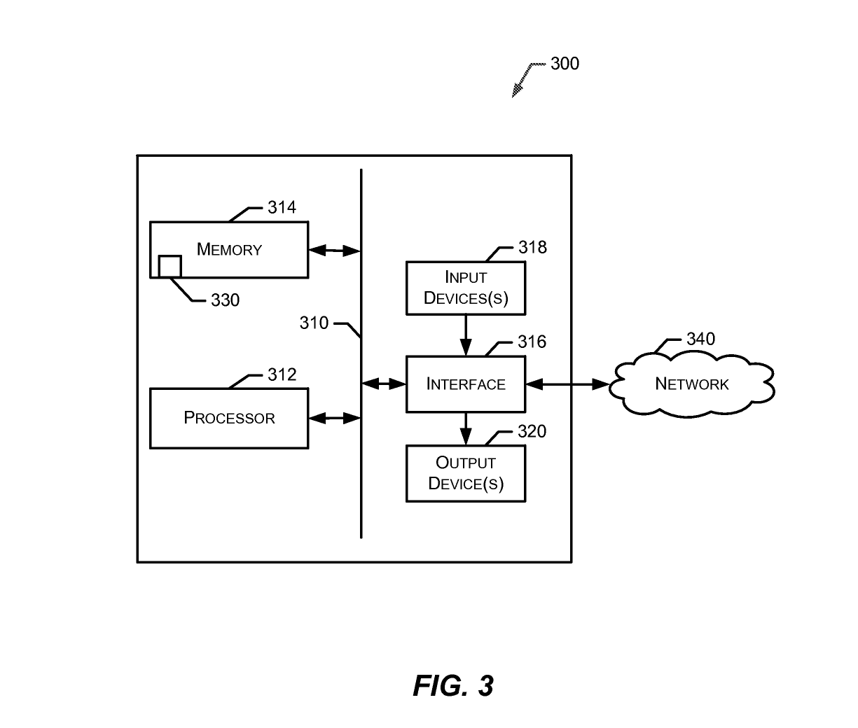

FIG. 3 illustrates a block diagram of an example computing device 300 which may be used to implement the disclosed embodiments. The trading device 110 of FIG. 1 may include one or more computing devices 300, for example. The gateway 120 of FIG. 1 may include one or more computing devices 300, for example. The exchange 130 of FIG. 1 may include one or more computing devices 300, for example.

The computing device 300 includes a communication network 310, a processor 312, a memory 314, an interface 316, an input device 318, and an output device 320. The computing device 300 may include additional, different, or fewer components. For example, multiple communication networks, multiple processors, multiple memory, multiple interfaces, multiple input devices, multiple output devices, or any combination thereof, may be provided. As another example, the computing device 300 may not include an input device 318 or output device 320.

As shown in FIG. 3, the computing device 300 may include a processor 312 coupled to a communication network 310. The communication network 310 may include a communication bus, channel, electrical or optical network, circuit, switch, fabric, or other mechanism for communicating data between components in the computing device 300. The communication network 310 may be communicatively coupled with and transfer data between any of the components of the computing device 300.

The processor 312 may be any suitable processor, processing unit, or microprocessor. The processor 312 may include one or more general processors, digital signal processors, application specific integrated circuits, field programmable gate arrays, analog circuits, digital circuits, programmed processors, and/or combinations thereof, for example. The processor 312 may be a single device or a combination of devices, such as one or more devices associated with a network or distributed processing. Any processing strategy may be used, such as multi-processing, multi-tasking, parallel processing, and/or remote processing. Processing may be local or remote and may be moved from one processor to another processor. In certain embodiments, the computing device 300 is a multi-processor system and, thus, may include one or more additional processors which are communicatively coupled to the communication network 310.

The processor 312 may be operable to execute logic and other computer readable instructions encoded in one or more tangible media, such as the memory 314. As used herein, logic encoded in one or more tangible media includes instructions which may be executable by the processor 312 or a different processor. The logic may be stored as part of software, hardware, integrated circuits, firmware, and/or micro-code, for example. The logic may be received from an external communication device via a communication network such as the network 340. The processor 312 may execute the logic to perform the functions, acts, or tasks illustrated in the figures or described herein.

The memory 314 may be one or more tangible media, such as computer readable storage media, for example. Computer readable storage media may include various types of volatile and non-volatile storage media, including, for example, random access memory, read-only memory, programmable read-only memory, electrically programmable read-only memory, electrically erasable read-only memory, flash memory, any combination thereof, or any other tangible data storage device. As used herein, the term non-transitory or tangible computer readable medium is expressly defined to include any type of computer readable medium and to exclude propagating signals. The memory 314 may include any desired type of mass storage device including hard disk drives, optical media, magnetic tape or disk, etc.

The memory 314 may include one or more memory devices. For example, the memory 314 may include local memory, a mass storage device, volatile memory, non-volatile memory, or a combination thereof. The memory 314 may be adjacent to, part of, programmed with, networked with, and/or remote from processor 312, so the data stored in the memory 314 may be retrieved and processed by the processor 312, for example. The memory 314 may store instructions which are executable by the processor 312. The instructions may be executed to perform one or more of the acts or functions described herein or shown in the figures.

The memory 314 may store a trading application 330. In certain embodiments, the trading application 330 may be accessed from or stored in different locations. The processor 312 may access the trading application 330 stored in the memory 314 and execute computer-readable instructions included in the trading application 330.

In certain embodiments, during an installation process, the trading application may be transferred from the input device 318 and/or the network 340 to the memory 314. When the computing device 300 is running or preparing to run the trading application 330, the processor 312 may retrieve the instructions from the memory 314 via the communication network 310.

### V. Strategy Trading

In addition to buying and/or selling a single tradeable object, a user may trade more than one tradeable object according to a trading strategy. One common trading strategy is a spread and trading according to a trading strategy may also be referred to as spread trading. Spread trading may attempt to capitalize on changes or movements in the relationships between the tradeable object in the trading strategy, for example.

An automated trading tool may be utilized to trade according to a trading strategy, for example. For example, the automated trading tool may include AUTOSPREADER®, provided by Trading Technologies.

A trading strategy defines a relationship between two or more tradeable objects to be traded. Each tradeable object being traded as part of a trading strategy may be referred to as a leg or outright market of the trading strategy.

When the trading strategy is to be bought, the definition for the trading strategy specifies which tradeable object corresponding to each leg should be bought or sold. Similarly, when the trading strategy is to be sold, the definition specifies which tradeable objects corresponding to each leg should be bought or sold. For example, a trading strategy may be defined such that buying the trading strategy involves buying one unit of a first tradeable object for leg A and selling one unit of a second tradeable object for leg B. Selling the trading strategy typically involves performing the opposite actions for each leg.

In addition, the definition for the trading strategy may specify a spread ratio associated with each leg of the trading strategy. The spread ratio may also be referred to as an order size for the leg. The spread ratio indicates the quantity of each leg in relation to the other legs. For example, a trading strategy may be defined such that buying the trading strategy involves buying 2 units of a first tradeable object for leg A and selling 3 units of a second tradeable object for leg B. The sign of the spread ratio may be used to indicate whether the leg is to be bought (the spread ratio is positive) or sold (the spread ratio is negative) when buying the trading strategy. In the example above, the spread ratio associated with leg A would be “2” and the spread ratio associated with leg B would be “−3.”

In some instances, the spread ratio may be implied or implicit. For example, the spread ratio for a leg of a trading strategy may not be explicitly specified, but rather implied or defaulted to be “1” or “−1.”

In addition, the spread ratio for each leg may be collectively referred to as the spread ratio or strategy ratio for the trading strategy. For example, if leg A has a spread ratio of “2” and leg B has a spread ratio of “−3”, the spread ratio (or strategy ratio) for the trading strategy may be expressed as “2:−3” or as “2:3” if the sign for leg B is implicit or specified elsewhere in a trading strategy definition.

Additionally, the definition for the trading strategy may specify a multiplier associated with each leg of the trading strategy. The multiplier is used to adjust the price of the particular leg for determining the price of the spread. The multiplier for each leg may be the same as the spread ratio. For example, in the example above, the multiplier associated with leg A may be “2” and the multiplier associated with leg B may be “−3,” both of which match the corresponding spread ratio for each leg. Alternatively, the multiplier associated with one or more legs may be different than the corresponding spread ratios for those legs. For example, the values for the multipliers may be selected to convert the prices for the legs into a common currency.

The following discussion assumes that the spread ratio and multipliers for each leg are the same, unless otherwise indicated. In addition, the following discussion assumes that the signs for the spread ratio and the multipliers for a particular leg are the same and, if not, the sign for the multiplier is used to determine which side of the trading strategy a particular leg is on.

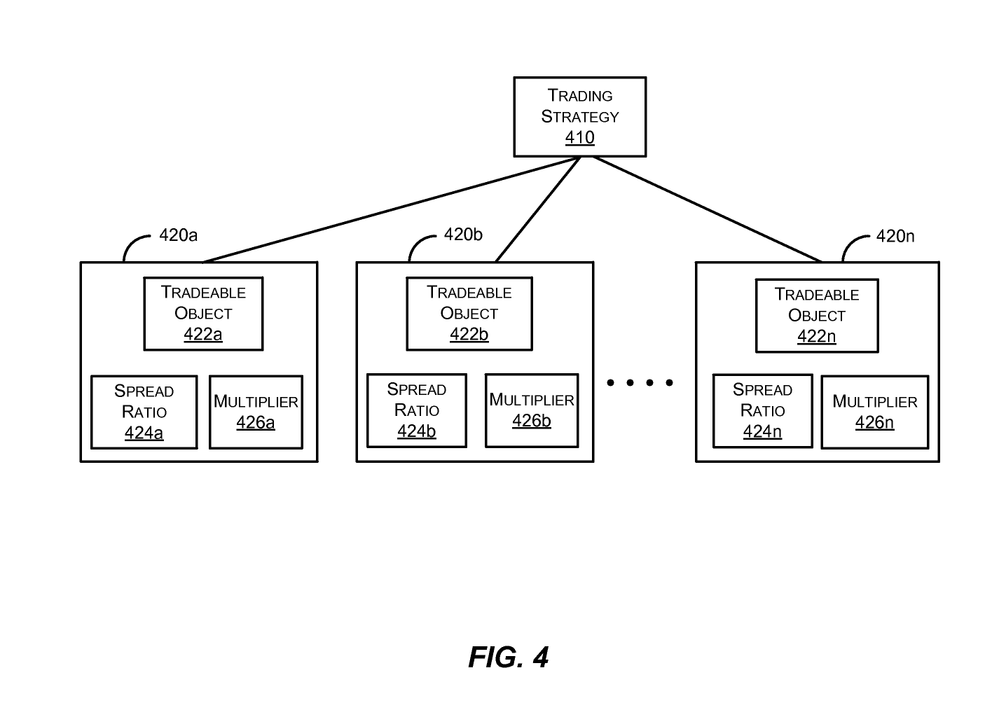

FIG. 4 illustrates a block diagram of a trading strategy 410 which may be employed with certain disclosed embodiments. The trading strategy 410 includes “n” legs 420 (individually identified as leg 420a to leg 420n). The trading strategy 410 defines the relationship between tradeable objects 422 (individually identified as tradeable object 422a to tradeable object 422n) of each of the legs 420a to 420n using the corresponding spread ratios 424a to 424n and multipliers 426a to 426n.

Once defined, the tradeable objects 422 in the trading strategy 410 may then be traded together according to the defined relationship. For example, assume that the trading strategy 410 is a spread with two legs, leg 420a and leg 420b. Leg 420a is for tradeable object 422a and leg 420b is for tradeable object 422b. In addition, assume that the spread ratio 424a and multiplier 426a associated with leg 420a are “1” and that the spread ratio 424b and multiplier 426b associated with leg 420b are “−1”. That is, the spread is defined such that when the spread is bought, 1 unit of tradeable object 422a is bought (positive spread ratio, same direction as the spread) and 1 unit of tradeable object 422b is sold (negative spread ratio, opposite direction of the spread). As mentioned above, typically in spread trading the opposite of the definition applies. That is, when the definition for the spread is such that when the spread is sold, 1 unit of tradeable object 422a is sold (positive spread ratio, same direction as the spread) and 1 unit of tradeable object 422b is bought (negative spread ratio, opposite direction of the spread).

The price for the trading strategy 410 is determined based on the definition. In particular, the price for the trading strategy 410 is typically the sum of price the legs 420a-420n comprising the tradeable objects 422a-422n multiplied by corresponding multipliers 426a-426n. The price for a trading strategy may be affected by price tick rounding and/or pay-up ticks. However, both of these implementation details are beyond the scope of this discussion and are well-known in the art.

Recall that, as discussed above, a real spread may be listed at an exchange, such as exchange 130 and/or 230, as a tradeable product. In contrast, a synthetic spread may not be listed as a product at an exchange, but rather the various legs of the spread are tradeable at one or more exchanges. For the purposes of the following example, the trading strategy 410 described is a synthetic trading strategy. However, similar techniques to those described below may also be applied by an exchange when a real trading strategy is traded.

Continuing the example from above, if it is expected or believed that tradeable object 422a typically has a price 10 greater than tradeable object 422b, then it may be advantageous to buy the spread whenever the difference in price between tradeable objects 422a and 422b is less than 10 and sell the spread whenever the difference is greater than 10. As an example, assume that tradeable object 422a is at a price of 45 and tradeable object 422b is at a price of 40. The current spread price may then be determined to be (1)(45)+(−1)(40)=5, which is less than the typical spread of 10. Thus, a user may buy 1 unit of the spread, which results in buying 1 unit of tradeable object 422a at a price of 45 and selling 1 unit of tradeable object 422b at 40. At some later time, the typical price difference may be restored and the price of tradeable object 422a is 42 and the price of tradeable object 422b is 32. At this point, the price of the spread is now 10. If the user sells 1 unit of the spread to close out the user's position (that is, sells 1 unit of tradeable object 422a and buys 1 unit of tradeable object 422b), the user has made a profit on the total transaction. In particular, while the user bought tradeable object 422a at a price of 45 and sold at 42, losing 3, the user sold tradeable object 422b at a price of 40 and bought at 32, for a profit of 8. Thus, the user made 5 on the buying and selling of the spread.

The above example assumes that there is sufficient liquidity and stability that the tradeable objects can be bought and sold at the market price at approximately the desired times. This allows the desired price for the spread to be achieved. However, more generally, a desired price at which to buy or sell a particular trading strategy is determined. Then, an automated trading tool, for example, attempts to achieve that desired price by buying and selling the legs at appropriate prices. For example, when a user instructs the trading tool to buy or sell the trading strategy 410 at a desired price, the automated trading tool may automatically place an order (also referred to as quoting an order) for one of the tradeable objects 422 of the trading strategy 410 to achieve the desired price for the trading strategy (also referred to as a desired strategy price, desired spread price, and/or a target price). The leg for which the order is placed is referred to as the quoting leg. The other leg is referred to as a lean leg and/or a hedge leg. The price that the quoting leg is quoted at is based on a target price that an order could be filled at in the lean leg. The target price in the hedge leg is also known as the leaned on price, lean price, and/or lean level. Typically, if there is sufficient quantity available, the target price may be the best bid price when selling and the best ask price when buying. The target price may be different than the best price available if there is not enough quantity available at that price or because it is an implied price, for example. As the leaned on price changes, the price for the order in the quoting leg may also change to maintain the desired strategy price.

The leaned on price may also be determined based on a lean multiplier and/or a lean base. A lean multiplier may specify a multiple of the order quantity for the hedge leg that should be available to lean on that price level. For example, if a quantity of 10 is needed in the hedge leg and the lean multiplier is 2, then the lean level may be determined to be the best price that has at least a quantity of 20 available. A lean base may specify an additional quantity above the needed quantity for the hedge leg that should be available to lean on that price level. For example, if a quantity of 10 is needed in the hedge leg and the lean base is 5, then the lean level may be determined to be the best price that has at least a quantity of 15 available. The lean multiplier and lean base may also be used in combination. For example, the lean base and lean multiplier may be utilized such that larger of the two is used or they may be used additively to determine the amount of quantity to be available.

When the quoting leg is filled, the automated trading tool may then submit an order in the hedge leg to complete the strategy. This order may be referred to as an offsetting or hedging order. The offsetting order may be placed at the leaned on price or based on the fill price for the quoting order, for example. If the offsetting order is not filled (or filled sufficiently to achieve the desired strategy price), then the strategy order is said to be “legged up” or “legged” because the desired strategy relationship has not been achieved according to the trading strategy definition.

In addition to having a single quoting leg, as discussed above, a trading strategy may be quoted in multiple (or even all) legs. In such situations, each quoted leg still leans on the other legs. When one of the quoted legs is filled, typically the orders in the other quoted legs are cancelled and then appropriate hedge orders are placed based on the lean prices that the now-filled quoting leg utilized.

### VI. Trading Strategy Management

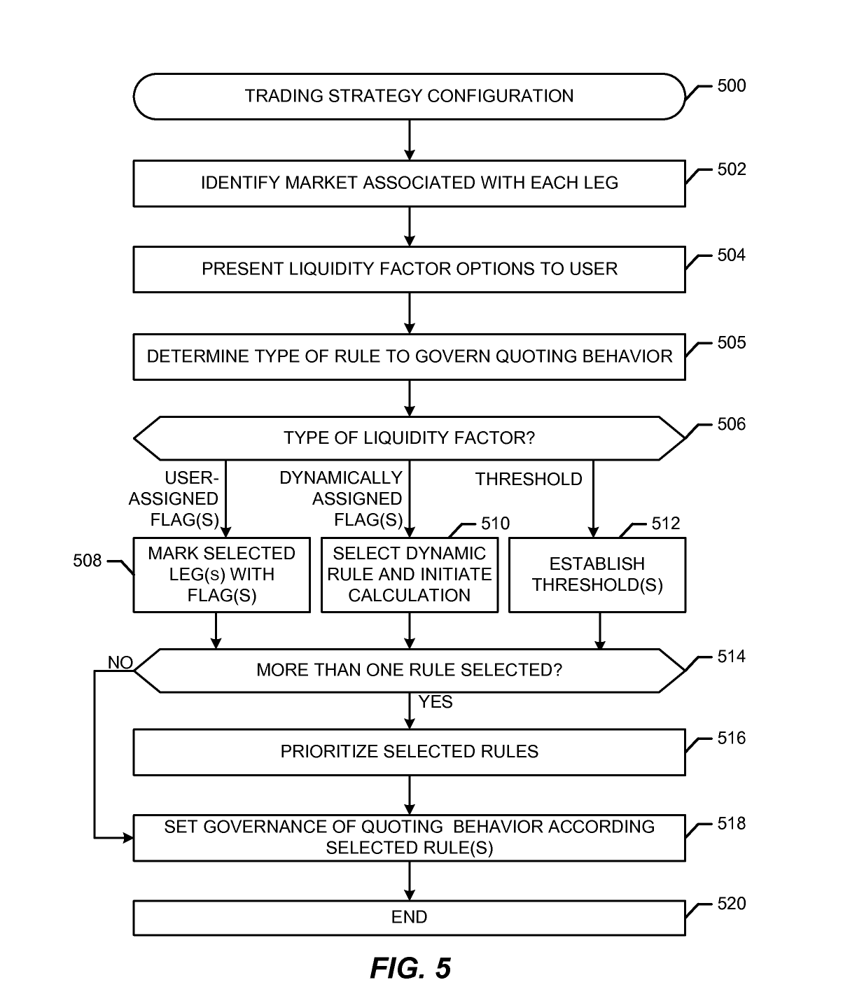

FIGS. 5-9 are flowcharts representative of example operations that can be executed to implement the teachings of this disclosure in connection with a trading strategy. The example operations of FIGS. 5-9 can be implemented by, for example, the trading application 330 stored on and executed by the example trading device 110 of FIG. 1 and/or the example trading device 210 of FIG. 2. While the example trading device 110 of FIG. 1 is described as implementing the example operations of FIGS. 5-9 below, any suitable device can implement the example operations of FIGS. 5-9.

In the examples of FIGS. 5-9, the trading strategy is a spread having at least two legs. As described in the previous section, operating such a trading strategy involves quoting a price in at least one of the legs. In known systems, the quoting of the trading strategy occurs, for example, in response to a market event or market activity. Example market events and/or market activity includes a change in quantity in one of the legs of the trading strategy, a change in price in one of the legs of the trading strategy, and/or any other event that triggers a price calculation associated with the trading strategy. In known systems that respond to each market event by re-quoting the trading strategy, the frequency at which the trading strategy is re-quoted can be excessive. For example, re-quoting frequently can incur excessive fees and/or may cause queue position to be lost at an exchange too often. The examples of FIGS. 5-9 describe and provide an efficient, cost-friendly, and customizable mechanism for the configuration of trading strategies. In particular, the examples of FIGS. 5-9 enable one or more parameters of the trading strategy associated with re-quoting to be based on one or more liquidity factors associated with one or more markets involved in the trading strategy. For instance, the examples of FIGS. 5-9 enable the trading strategy to limit re-quoting to situations where one or more market event(s) occurs in an illiquid market involved in the trading strategy. Due at least in part to the higher difficulty of filling orders in illiquid markets as opposed to liquid markets, the ability to base re-quoting on the less (or least) liquid market(s) enables the user to re-quote based on market activity that is more impactful on the trading strategy than other market activity. That is, a first market event in a liquid market is less likely to impact the ability to fill an order of the trading strategy than a second market event in an illiquid market. Accordingly, market activity in the second market is has a greater impact or influence on, for example, a likelihood of an order being filled (or legged). Thus, the examples of FIGS. 5-9 enable the user to focus or limit re-quoting to instances of meaningful or impactful market activity. In doing so, the examples of FIGS. 5-9 can reduce the frequency of re-quoting while maintaining effectiveness of the trading strategy.

FIG. 5 illustrates example operations to manage, configure and/or define a trading strategy in accordance with teachings of this disclosure (block 500). For purposes of illustration, FIG. 5 refers to the example trading strategy 410 of FIG. 4. However, the example of FIG. 5 may be implemented in connection with any suitable trading strategy involving combinations of tradeable objects offered in liquid and illiquid markets. As described above in connection with FIG. 4, the trading strategy 410 includes multiple legs 420, tradeable objects 422, spread ratios 424, and multipliers 426. The example trading strategy 410 may include additional or alternative parameters.

In the example of FIG. 5, the trading device 110 identifies a market for each of the legs 420 (block 502). Each of the tradeable objects 422 of the trading strategy 410 and, thus, the corresponding one of the legs 420, is traded on a particular market. To identify the market for each of the legs 420, the trading device 110 analyzes one or more parameters of the definition of the trading strategy (for example, as provided by a user). Alternatively, the market for each leg 420 may be determined based on knowledge of the markets in which particular tradeable objects are traded. In the example of FIG. 5, the trading device 110 utilizes any additional or alternative technique or method to identify the market for each of the legs 420. In the illustrated example of FIG. 5, the trading device 110 determines that the first leg 420a of the trading strategy is associated with (for example, is being traded in) a first market (Market A) and the second leg 420b is associated with (for example, is being traded in) a second market (Market B) that is different than Market A.

In the illustrated example of FIG. 5, the trading device 110 presents options to the user for defining one or more parameters of the trading strategy 410, such as the quoting behavior of the trading strategy 410, to be governed or least influenced by one or more liquidity factors associated with one or more of the identified markets (block 504). Put another way, in the example of FIG. 5, the trading device 110 enables the user to configure the quoting behavior of the trading strategy 410 to be dependent on the liquidity factor(s) associated with the market(s) of the legs 420. The quoting behavior defined by the example of FIG. 5 includes, for example, a rule that governs when the trading strategy 410 is quoted and/or re-quoted. Thus, when the rule governing the re-quoting of the trading strategy 410 is satisfied, the trading device 110 takes a quoting action (for example, a re-quoting) for the trading strategy 410. In the example of FIG. 5, the trading device 110 enables the user to select one or more rules from a plurality of rules that utilize one or more liquidity factors associated with the market(s) of the trading strategy (block 505). In the example of FIG. 5, the trading device 110 determines which one(s) of the rules are selected to govern the quoting behavior of the trading strategy 410.

A first example rule selectable by the user in the example of FIG. 5 includes a flag that is assigned to one or more of the legs 420 of the trading strategy 410. As described above, each of the legs 420a to 420n is associated with a particular market. For example, leg 420a may be associated with Market A, leg 420b may be associated with Market B, and the remaining legs may similarly be associated with different markets. In the example of FIG. 5, market activity in the market associated with the flagged leg(s) governs the quoting behavior of the trading strategy 410. For example, when the user assigns the flag only to the first leg 420a of the trading strategy 410, occurrence of a market event in Market A (but not a market event in Market B) causes the trading strategy 410 to be re-quoted. In some examples, the user assigns a flag to multiple legs 420 of the trading strategy 410. For example, when the user assigns the flag to the first leg 420a and the second leg 420b, occurrence of a market event in either Market A or Market B causes the trading strategy 410 to be re-quoted.

In some examples, the user and/or the trading device 110 has knowledge of a general (for example, average) liquidity of the individual markets involved in the trading strategy 410 based on, for example, statistics indicative of the liquidity over a period of time (for example, the last month, the last quarter, the last year, the last years, etc.). As such, the user and/or the trading device 110 (on behalf of the user) assigns the flag to particular market(s) based on the liquidity of the markets relative to, for example, each other. In some examples, the trading device 110 flags whichever of the markets is/are the most illiquid (for example, over the past year). In the illustrated example of FIG. 5, the flag may be assigned to the first leg 420a of the trading strategy 410 because Market A is illiquid compared to the market (Market B) associated with the second leg 420b (and the markets associated with the other legs 420n). The assigned flag(s) may be visually depicted and/or identified as part of the trading application presented by the trading device 110. In another configuration, the assigned flag(s) may be a logical trigger (with or without a visual representation) that corresponds or reflects the liquidity of one or more markets.

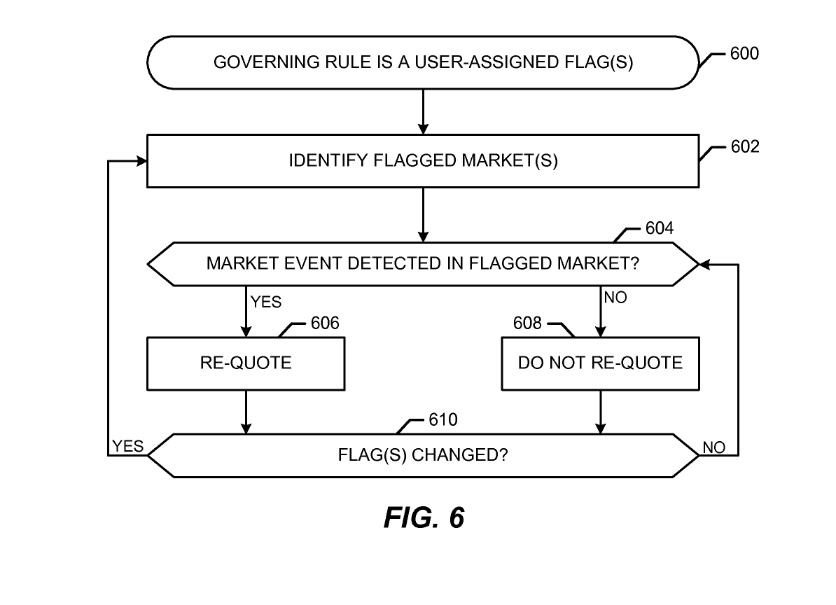

Thus, the example of FIG. 5 enables the quoting behavior (for example, when re-quoting occurs) to be based on (for example, respond to) market activity in the less (or least) liquid of the markets involved in the trading strategy 410 according to, for example, statistics indicative of past liquidity. While the user can adjust the assignment of the flag(s), the assignment in the example of FIG. 5 remains fixed until the user adjusts the assignment. In the example of FIG. 5, when such a rule is selected (block 506), the trading device 110 marks the selected leg with the flag (block 508). Example implementation of the trading strategy 410 after the flag is assigned is disclosed below in connection with FIG. 6.

A second example rule selectable by the user in the example of FIG. 5 includes a dynamic flag that is dynamically assigned to one or more of the legs 420 of the trading strategy 410. The dynamic flag of FIG. 5 is assigned based on current liquidity of the markets. In the example of FIG. 5, the trading device 110 periodically calculates the liquidity of each market involved in the trading strategy 410 and assigns the flag(s) according to the up to date liquidity calculations. Thus, rather than the user and/or the trading device 110 assigning the flag based on past statistics or general knowledge of the liquidity of the markets (as in the first example rule disclosed above), the dynamic flag(s) of FIG. 5 enables the quoting behavior of the trading strategy 410 to be governed by real-time liquidity characteristics of the markets.

For example, at a first time, the trading device 110 determines that Market A is less liquid than Market B, but that Market A is more liquid than Market B at a second time later than the first time. In response, the trading device 110 assigns the dynamic flag of FIG. 5 to the first leg 420a at the first time, and the trading device 110 assigns the dynamic flag of FIG. 5 to the second leg 420 at the second time. In some examples, more than one of the legs 420 is flagged based on the real-time data such as, for example, the two least liquid markets at a given time. In the example of FIG. 5, when such a rule is selected (block 506), the trading device 110 configures the trading strategy quoting behavior to be governed by the dynamic rule and configures the periodic calculation of the market liquidities (for example, by setting a schedule and initiating the first calculations) (block 510).

A third example rule selectable by the user in the example of FIG. 5 includes a liquidity threshold that needs to be met before the trading strategy 410 is re-quoted. In some examples, an individual threshold is assigned to individual ones of the legs 420 of the trading strategy 410. In some examples, a global threshold is applied across some or all of the legs 420 of the trading strategy 410. In the example of FIG. 5, the threshold represents a liquidity above which a market event occurring in the corresponding market will not trigger a re-quote of the trading strategy 410. Put another way, as long as the liquidity of the market is below the threshold, market events in that market will trigger a re-quote. Additional or alternative thresholds can be implemented. For example, a user may desire the inverse behavior and, thus, may configure the threshold that causes restriction on re-quoting when liquidity is below a threshold.

Thus, the liquidity threshold(s) of the example of FIG. 5 enable the user and/or the trading device 110 to prevent markets of undesirable liquidity characteristics from governing the quoting behavior of the trading strategy 410. As a result, only more meaningful and/or impactful market activity, such as a market event in an illiquid market, affects the quoting behavior of the trading strategy 410. For example, if a market event is detected in Market A and a threshold (for example, a threshold specific to Market A or a global threshold to be applied across the markets) has been assigned to Market A, the trading device 110 determines a current liquidity of Market A and compares the calculated liquidity to the threshold. A determination of current market conditions may be made in real-time by an evaluation of the market, or could be obtained directly from the exchange or indirectly from a device or system in communication with the exchange. If the current liquidity of Market A meets the threshold (for example, Market A is sufficiently illiquid), the trading device 110 triggers re-quoting of the trading strategy 410. If the current liquidity of Market A does not meet the threshold, the trading device 110 does not trigger re-quoting of the trading strategy 410. In the example of FIG. 5, a market event detected in Market B can additionally or alternatively trigger re-quoting of the trading strategy 410 when the market event coincides with the liquidity of Market B meeting the appropriate threshold. In the example of FIG. 5, when such a rule is selected (block 506), the trading device 110 configures the trading strategy quoting behavior to adhere to the selected threshold(s) (block 512).

In some examples, more than one of the example rules of FIG. 5 are selected to govern the quoting behavior of the trading strategy 410 (block 514). If so, the example trading device 110 prioritizes the selected rules (block 516). For example, the trading device 110 designates a first one of the selected rules as having the highest priority, a second one of the selected rules as having a second highest priority, etc. In such instances, if the highest priority one of the rules indicates that the trading strategy 410 should be re-quoted, the trading device 110 re-quotes the trading strategy without evaluating the other selected rules. Alternatively, if the highest priority one of the rules indicates that the trading strategy 410 should not be re-quoted but the second highest priority one of the rules indicates that the trading strategy 410 should be re-quoted, the trading device 110 re-quotes the trading strategy 410. In some examples, the user is presented with an interface to enable the user to set the priority.

In the example of FIG. 5, the trading device 110 sets the governance of one or more aspects of the quoting behavior of the trading strategy 410 according to the selected rule(s) (block 518). Setting the governance of the aspect(s) of the quoting behavior includes, for example, assigning a value to a definition of the trading strategy 410 associated with re-quoting of the trading strategy 410. The example of FIG. 5 then ends (block 520).

FIG. 6 illustrates example operations to govern at least one aspect of the quoting behavior of the trading strategy 410 when the example user-assigned flag rule of FIG. 5 is selected (at block 508). As described above, in such instances, market activity in the market(s) associated with the flagged leg(s) (for example, as assigned by the user) governs the quoting behavior of the trading strategy 410 (block 600). In the example of FIG. 6, the market(s) associated with the flagged leg(s) 420 is/are identified (block 602). The example trading device 110 monitors the identified market(s) for market activity (block 604). When a market event is detected in the monitored market(s) (block 604), such as a change in price or a change in available quantity, the trading device 110 re-quotes the trading strategy 410 (block 606). On the other hand, when a market event is not detected in the monitored market(s), the trading device 110 does not re-quote the trading strategy 410 (block 608). Notably, even if a market event occurs in one of the markets corresponding to the non-flagged legs 420, the trading strategy 410 is not re-quoted in the example of FIG. 6. In the illustrated example, the user is given an opportunity to change the leg(s) to which the flag(s) is/are assigned (block 610). If the flag(s) is/are changed, control returns to block 602. Otherwise, control returns to block 604).

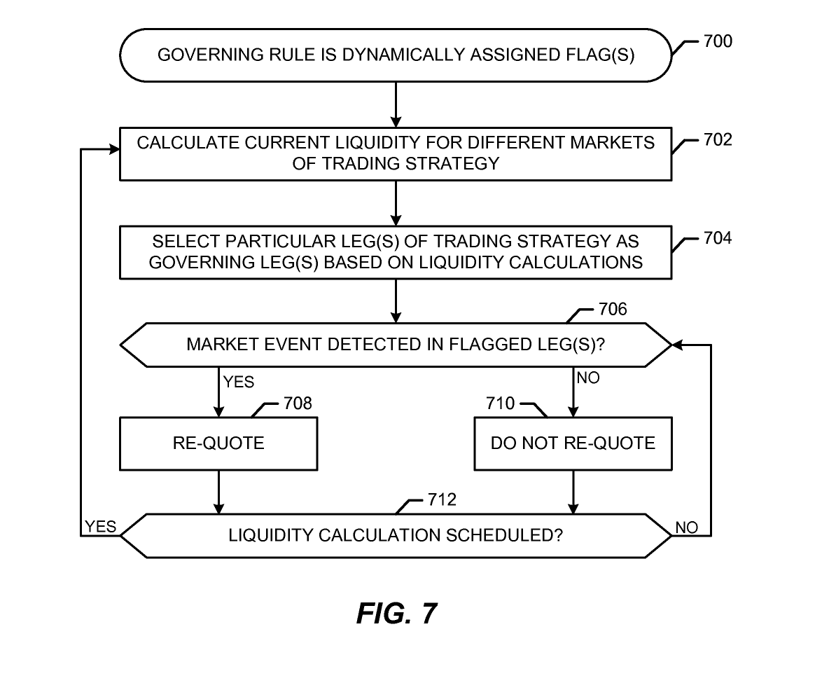

FIG. 7 illustrates example operations to govern at least one aspect of the quoting behavior of the trading strategy 410 when the example dynamic flag rule of FIG. 5 is selected (at block 510). As described above, in such instances, liquidity is dynamically measured for the different markets of the trading strategy 410 and at least one of the corresponding legs 420 (for example, the leg 420 associated with the lease liquid one of the markets) is flagged to govern the quoting behavior of the trading strategy 410 at respective times (block 700). In the example of FIG. 7, the trading device 110 calculates a current liquidity of the market associated with each leg, such as Market A associated with the first leg 420a and Market B associated with the second leg 420b (block 702). The trading device 110 utilizes any suitable technique or algorithm to determine a current (for example, real-time) liquidity measurement. Measurements and/or techniques to determine current liquidity may include: calculating the amount or quantity of contracts currently available on both the bid and ask sides of a given market; establishing a threshold of quantity available on the bid/ask sides; and/or determining the number of contracts available on both the bid and ask sides of a given market over a predefined period of time (e.g., relative to the previous trading day, within the last hour or any other desired period.)

In the example of FIG. 7, based on the current liquidity measurements, the trading device 110 selects one (for example, the least liquid according to the real-time data) or more (for example, the two least liquid according to the real-time data) of the legs 420 as governing the quoting behavior of the trading strategy 410 (block 704). For example, if Market A is determined to be illiquid compared to Market B (and the remaining markets corresponding to the remaining legs 420n, if any), the trading device 110 flags the first leg 420a. Conversely, if Market A is determined to be more liquid than Market B (and Market B is less liquid than the remaining markets corresponding to the remaining legs 420n, if any), the trading device 110 flags the second leg 420b. The example trading device 110 monitors the market corresponding to the currently flagged leg(s) 420 for market activity (block 706). When a market event is detected in the monitored market(s) (block 706), such as a change in price or a change in available quantity, the trading device 110 re-quotes the trading strategy 410 (block 708). On the other hand, when a market event is not detected in the monitored market(s), the trading device 110 does not re-quote the trading strategy 410 (block 710). Notably, even if a market event occurs in one of the markets corresponding to the non-flagged legs 420, the trading strategy 410 is not re-quoted in the example of FIG. 7. In the illustrated example, the liquidity calculation is based on a schedule. If the next set of liquidity calculations is due or scheduled (block 712), control returns to block 702. Otherwise, control returns to block 706.

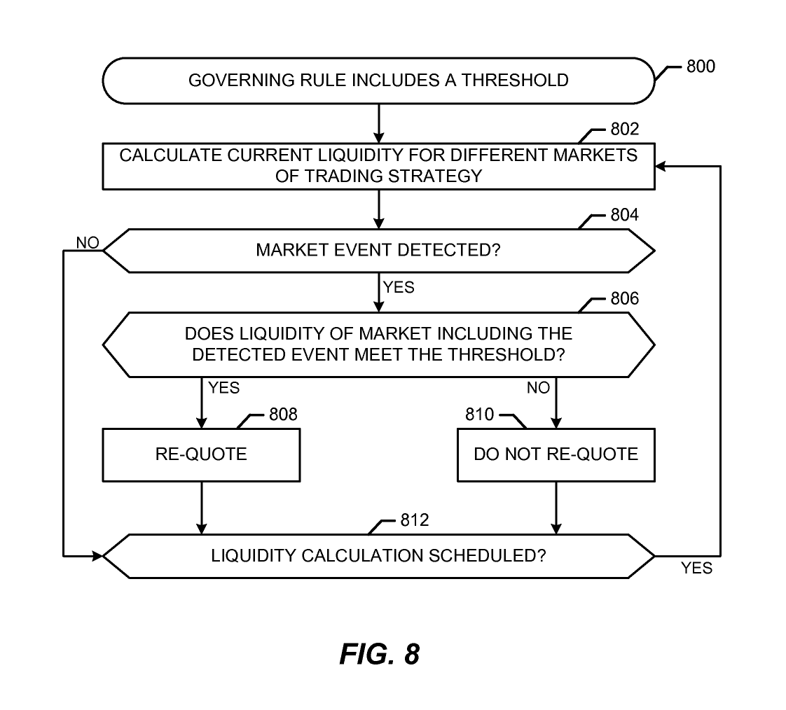

FIG. 8 illustrates example operations to govern at least one aspect of the quoting behavior of the trading strategy 410 when the example threshold rule of FIG. 5 is selected (at block 512). As described above, the threshold(s) of FIG. 5 enable the user and/or the trading device 110 to prevent markets of undesirable liquidity characteristics from governing the quoting behavior of the trading strategy 410 (block 800).

In the example of FIG. 8, the trading device 110 calculates a current liquidity of the market associated with each leg, such as Market A associated with the first leg 420a and Market B associated with the second leg 420b (block 802). The trading device 110 utilizes any suitable technique or algorithm to determine a current (for example, real-time) liquidity measurement. Measurements and/or techniques to determine current liquidity may include: calculating the amount or quantity of contracts currently available on both the bid and ask sides of a given market; establishing a threshold of quantity available on the bid/ask sides; and/or determining the number of contracts available on both the bid and ask sides of a given market over a predefined period of time (e.g., relative to the previous trading day, within the last hour or any other desired period.)

The example trading device 110 monitors the markets of the trading strategy 410 for market activity (block 804). In the example of FIG. 8, when a market event is detected in any of the markets of the trading strategy 410 (block 804), such as a change in price or a change in available quantity, the trading device determines whether the current liquidity of the market in which the activity is detected meets a threshold (block 806). For example, the threshold in the example of FIG. 8 is a liquidity value above which the detected market will not trigger a re-quote. If the liquidity meets the threshold (block 806), the trading device 110 re-quotes the trading strategy 410 (block 808). On the other hand, when the liquidity of the market does not meet threshold (block 806), the trading device 110 does not re-quote the trading strategy 410 (block 810). Notably, even if a market event occurs in one of the markets, the trading strategy 410 is not re-quoted unless that market is, for example, sufficiently illiquid.

In the illustrated example, the liquidity calculations of block 802 are subject to a schedule. If the next set of liquidity calculations is due or scheduled (block 812), control returns to block 802. Otherwise, control returns to block 804. Further, in some examples, the threshold(s) may be adjusted by, for example, the user and/or the trading device 110 on behalf of the user. In such instances, the calculations of block 802 may be initiated in response to an adjustment of the threshold(s).

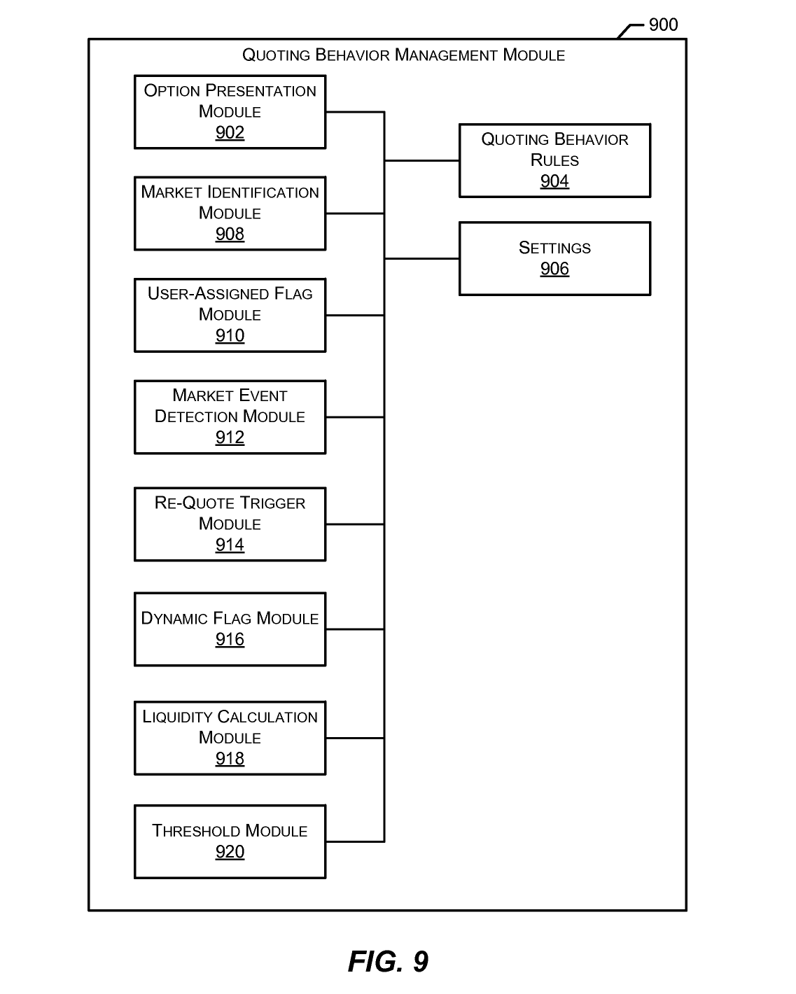

FIG. 9 is a block diagram representative of an example quoting behavior management module 900 that can implement the example machine readable instructions of FIGS. 5, 6, 7, and/or 8. In some examples, the quoting behavior management module 900 may be implemented as a part of the trading application 330 associated with the trading device 110 of FIG. 1 and/or the trading device 210 of FIG. 2. In some examples, the quoting behavior management module 900 may be implemented as computer implemented code or instructions operable independent of a trading application. In some examples, the features and functionality of the quoting behavior management module 900 may be implemented in hardware operable in connection with the trading device 110 of FIG. 1 and/or the trading device 210 of FIG. 2.

The example quoting behavior management module 900 of FIG. 9 enables the user associated with, for example, the trading strategy 410 of FIG. 4 to cause one or more aspects of the corresponding quoting behavior to depend on, for example, one or more liquidity characteristics of the markets involved in the trading strategy 410. For example, the quoting behavior management module 900 of FIG. 9 enables the user to control when the trading strategy 410 is re-quoted by determining one or more circumstances in which market activity causes the trading strategy to be re-quoted. The example quoting behavior management module 900 of FIG. 9 provides a plurality of rules as scenarios or options for governing the quoting behavior of the trading strategy 410. To present the user with the options, the example quoting behavior management module 900 of FIG. 9 includes an option presentation module 902. In the example of FIG. 9, the option presentation module 902 facilitates display of the different options to the user in connection with, for example, a configuration interface associated with the trading strategy 410. The example quoting behavior management module 900 of FIG. 9 includes a set of quoting behavior rules 904 that may be customized and/or updated. Further, when one of the quoting behavior rules 904 is selected, one or more settings 906 associated with the trading strategy 410 are set according to the selection, as further described below. The example settings 906 of FIG. 9 include, for example, one or more statements and/or data structures that define the trading strategy 410.

In some examples, the presentation of the scenarios or options includes indications or identifications of which markets are involved in the trading strategy 410. The example quoting behavior management module 900 of FIG. 9 includes a market identification module 908 to identify which markets are involved in the trading strategy 410. In the illustrated example of FIG. 9, the market identification module 908 identifies the tradeable object(s) 422 of each leg 420 of the trading strategy 410 and, thus, is aware of which markets are involved in the trading strategy 410 via, for example, a lookup function. The example market identification module 908 tracks which leg 420 is associated with which market (for example, by associating an identifier with each of the legs 420 in a configuration definition corresponding to the trading strategy 410).

A first example of the quoting behavior rules 904 presented by the example options presentation module 902 of FIG. 9 is implemented by a user-assigned flag module 910. In the example of FIG. 9, the user-assigned flag module 910 enables the user to select one or more of the legs 420 as the governing leg(s) for the trading strategy 410 in terms of, for example, re-quoting behavior. For example, when the user selects Market A associated with the first leg 420a, the user-assigned flag module 910 flags the first leg 420a, thereby making the re-quoting of the trading strategy 410 responsive to activity in Market A (but not Market B). In some examples, the user selects Market A and Market B which causes the user-assigned flag module 910 to flag the first leg 420a and the second leg 420b, thereby making the re-quoting of the trading strategy 410 responsive to activity in Market A and activity in Market B (but not other markets 420n). The flags assigned by the example user-assigned flag module 910 are reflected in the example settings 906 as fixed selections, which may be changed or updated by the user. For example, the user may be prompted to change or update the flag assignments periodically. If the user does not change the flag assignment(s) in the example of FIG. 9, the assigned flags remain fixed in the example settings 906.

In the illustrated example of FIG. 9, the user-assigned flag module 910 cooperates with a market event detection module 912 to determine whether market activity has occurred in a market associated with a flagged leg. In the example of FIG. 9, the user-assigned flag module 910 informs the market event detection module 912 as to which market(s) are flagged and, thus, which market(s) to monitor for market activity. When the example market event detection module 912 detects a market event in the monitored market(s), the market event detection module 912 conveys an indication to a re-quote trigger module 914 that the trading strategy 410 is to be re-quoted. The example re-quote trigger module 914 of FIG. 9 responds to the indication by causing the trading strategy 410 to be re-quoted.

A second example of the quoting behavior rules 904 presented by the example options presentation module 902 of FIG. 9 is implemented by a dynamic flag module 916. In the example of FIG. 9, the dynamic flag module 916 enables the user to base which leg(s) 420 govern the quoting behavior of the trading strategy 410 on real-time liquidity calculations. For example, the user can configure the dynamic flag module 916 to select the leg 420 associated with the least liquid market according to real-time (or near real-time) data. The example dynamic flag module 916 cooperates with a liquidity calculation module 918 to flag one or more of the legs 420 as governing the quoting behavior. The example liquidity calculation module 918 calculates one or more liquidity measurements and/or values for each market involved in the trading strategy 410 over, for example, a most recent period of time (for example, the last ten seconds, the last minute, the last five minutes, the last hour, etc.). The example liquidity calculation module 918 of FIG. 9 utilizes any suitable technique and/or algorithm to generate the liquidity measurements. Using the liquidity measurements, the example dynamic flag module 916 of FIG. 9 flags one or more of the legs 420, thereby making the re-quoting of the trading strategy 410 responsive to activity in the market(s) associated with the flagged leg(s) 420. The current flags assigned by the example dynamic flag module 916 are reflected in the example settings 906 as the flags are assigned (for example, in real-time). The user can configure the example dynamic flag module 916 to select, for example, a least liquid market, the two least liquid markets, etc. The user may be prompted to change or update the configuration periodically.

In the illustrated example of FIG. 9, the dynamic flag module 916 cooperates with the market event detection module 912 to determine whether market activity has occurred in a market associated with a flagged leg. In the example of FIG. 9, the dynamic flag module 916 informs the market event detection module 912 as to which market(s) are flagged and, thus, which market(s) to monitor for market activity. When the example market event detection module 912 detects a market event in the monitored market(s), the market event detection module 912 conveys an indication to the re-quote trigger module 914 that the trading strategy 410 is to be re-quoted. The example re-quote trigger module 914 of FIG. 9 responds to the indication by causing the trading strategy 410 to be re-quoted.

A third example of the quoting behavior rules 904 presented by the example options presentation module 902 of FIG. 9 is implemented by a threshold module 920. In the example of FIG. 9, the threshold module 920 enables the user to ensure that only market activity meeting a threshold triggers a re-quote of the trading strategy 410. For example, the user can configure the threshold module 920 to set a global liquidity threshold that applies to each market involved in the trading strategy 410 or individual thresholds to each of the markets. In the illustrated example, the configuration of the threshold(s) is stored in the settings 906. The example threshold module 920 utilizes the market event detection module 912 to determine when a market event has occurred in any of the markets associated with the legs 420 of the trading strategy 410. When the market event detection module 912 detects a market event in a particular market, the example threshold module 920 requests a current liquidity measurement for that particular market from the example liquidity calculation module 918, which calculates the requested liquidity over, for example, a most recent period of time (for example, the last ten seconds, the last minute, the last five minutes, the last hour, etc.). The example threshold module 920 of FIG. 9 compares the calculated liquidity to the corresponding threshold (for example, a global threshold or the threshold assigned to the particular market). If the calculated liquidity of the particular market meets the threshold, the threshold module 920 conveys an indication to the re-quote trigger module 914 that the trading strategy 410 is to be re-quoted. The example re-quote trigger module 914 of FIG. 9 responds to the indication by causing the trading strategy 410 to be re-quoted. If the calculated liquidity of the particular market does not meet the threshold, the threshold module 920 does not convey the indication to re-quote to the re-quote trigger module 914.

Some of the described figures depict example block diagrams, systems, and/or flow diagrams representative of methods that may be used to implement all or part of certain embodiments. One or more of the components, elements, blocks, and/or functionality of the example block diagrams, systems, and/or flow diagrams may be implemented alone or in combination in hardware, firmware, discrete logic, as a set of computer readable instructions stored on a tangible computer readable medium, and/or any combinations thereof, for example.

The example block diagrams, systems, and/or flow diagrams may be implemented using any combination of application specific integrated circuit(s) (ASIC(s)), programmable logic device(s) (PLD(s)), field programmable logic device(s) (FPLD(s)), discrete logic, hardware, and/or firmware, for example. Also, some or all of the example methods may be implemented manually or in combination with the foregoing techniques, for example.

The example block diagrams, systems, and/or flow diagrams may be performed using one or more processors, controllers, and/or other processing devices, for example. For example, the examples may be implemented using coded instructions, for example, computer readable instructions, stored on a tangible computer readable medium. A tangible computer readable medium may include various types of volatile and non-volatile storage media, including, for example, random access memory (RAM), read-only memory (ROM), programmable read-only memory (PROM), electrically programmable read-only memory (EPROM), electrically erasable read-only memory (EEPROM), flash memory, a hard disk drive, optical media, magnetic tape, a file server, any other tangible data storage device, or any combination thereof. The tangible computer readable medium is non-transitory.

Further, although the example block diagrams, systems, and/or flow diagrams are described above with reference to the figures, other implementations may be employed. For example, the order of execution of the components, elements, blocks, and/or functionality may be changed and/or some of the components, elements, blocks, and/or functionality described may be changed, eliminated, sub-divided, or combined. Additionally, any or all of the components, elements, blocks, and/or functionality may be performed sequentially and/or in parallel by, for example, separate processing threads, processors, devices, discrete logic, and/or circuits.

While embodiments have been disclosed, various changes may be made and equivalents may be substituted. In addition, many modifications may be made to adapt a particular situation or material. Therefore, it is intended that the disclosed technology not be limited to the particular embodiments disclosed, but will include all embodiments falling within the scope of the appended claims.

What is claimed is:

1. A method comprising:
defining a trading strategy having a first leg associated with a first tradeable object and a second leg associated with a second tradeable object, wherein the first and second tradeable objects are listed on an electronic exchange;
defining a quoting behavior rule for the trading strategy, wherein the quoting behavior rule establishes at least a first liquidity associated with the first leg or a second liquidity associated with the second leg;
communicating the trading strategy to the electronic exchange;
receiving an update from the electronic exchange, the update reflects market activity related to trading strategy; and
determining whether to re-quote the trading strategy based on the market activity received as part of the update and the quoting behavior rule.

2. The method of claim 1, wherein:
defining the quoting behavior rule comprises assigning a flag to the first leg according to a user selection; and
determining whether to re-quote the trading strategy based on the market activity and the quoting behavior rule comprises:
monitoring activity in a first market associated with the first leg; and
triggering re-quoting of the trading strategy in response to a first event in the first market.

3. The method of claim 2, wherein determining whether to re-quote the trading strategy based on the market activity and the quoting behavior rules comprises:
not monitoring a second market associated with the second leg for the market activity; and
not triggering re-quoting of the trading strategy in response to a second event in the second market.

4. The method of claim 1, wherein:
defining the quoting behavior rule comprises:
dynamically calculating a first liquidity of a first market associated with the first leg;
dynamically calculating a second liquidity of a second market associated with the second leg; and
selecting one of the first or second markets according to a relationship between the first and second liquidities; and
determining whether to re-quote the trading strategy based on the market activity and the quoting behavior rule comprises:
monitoring the selected one of the first and second markets for the market activity; and
triggering re-quoting of the trading strategy in response to a first event in the selected one of the first and second markets.

5. The method of claim 4, wherein determining whether to re-quote the trading strategy based on the market activity and quoting behavior rule comprises:
not monitoring an unselected one of the first and second markets; and
not triggering re-quoting of the trading strategy in response to a second event in the unselected one of the first and second markets.

6. The method of claim 4, wherein selecting one of the first or second markets according to the relationship between the first and second liquidities comprises selecting a least significant one of the first and second liquidities.

7. The method of claim 1, wherein:
defining the quoting behavior comprises setting a threshold; and
determining whether to re-quote the trading strategy based on the market activity and the quoting behavior rule comprises:
calculating a liquidity of a first market associated with a market event;
comparing the liquidity of the first market to the threshold; and
triggering re-quoting of the trading strategy when the liquidity of the first market meets the threshold.

8. The method of claim 7, wherein determining whether to re-quote the trading strategy based on the market activity and quoting behavior rule comprises not triggering re-quoting of the trading strategy when the liquidity of the first market does not meet the threshold.

9. A tangible computer readable medium comprising instructions that, when executed, cause a machine to at least:
define a trading strategy having a first leg associated with a first tradeable object and a second leg associated with a second tradeable object, wherein the first and second tradeable objects are listed on an electronic exchange;
define a quoting behavior rule for the trading strategy, wherein the quoting behavior rule establishes at least a first liquidity associated with the first leg or a second liquidity associated with the second leg;
communicate the trading strategy to the electronic exchange;
receive an update from the electronic exchange, the update reflects market activity related to trading strategy; and
determine whether to re-quote the trading strategy based on the market activity received as part of the update and the quoting behavior rule.

10. The tangible computing readable medium of claim 9, wherein:
defining the quoting behavior rule comprises assigning a flag to the first leg according to a user selection; and
determining whether to re-quote the trading strategy based on the market activity and the quoting behavior rule comprises:
monitoring activity in a first market associated with the first leg; and
triggering re-quoting of the trading strategy in response to a first event in the first market.

11. The tangible computing readable medium of claim 10, wherein determining whether to re-quote the trading strategy based on the market activity and the quoting behavior rules comprises:
not monitoring a second market associated with the second leg for the market activity; and
not triggering re-quoting of the trading strategy in response to a second event in the second market.

12. The tangible computing readable medium of claim 9, wherein:
defining the quoting behavior rule comprises:
dynamically calculating a first liquidity of a first market associated with the first leg;
dynamically calculating a second liquidity of a second market associated with the second leg; and
selecting one of the first or second markets according to a relationship between the first and second liquidities; and
determining whether to re-quote the trading strategy based on the market activity and the quoting behavior rule comprises:
monitoring the selected one of the first and second markets for the market activity; and
triggering re-quoting of the trading strategy in response to a first event in the selected one of the first and second markets.

13. The tangible computing readable medium of claim 12, wherein determining whether to re-quote the trading strategy based on the market activity and quoting behavior rule comprises:
not monitoring an unselected one of the first and second markets; and
not triggering re-quoting of the trading strategy in response to a second event in the unselected one of the first and second markets.

14. The tangible computing readable medium of claim 12, wherein selecting one of the first or second markets according to the relationship between the first and second liquidities comprises selecting a least significant one of the first and second liquidities.

15. The tangible computing readable medium of claim 9, wherein:
defining the quoting behavior comprises setting a threshold; and
determining whether to re-quote the trading strategy based on the market activity and the quoting behavior rule comprises:
calculating a liquidity of a first market associated with a market event;
comparing the liquidity of the first market to the threshold; and
triggering re-quoting of the trading strategy when the liquidity of the first market meets the threshold.

16. The tangible computing readable medium of claim 15, wherein determining whether to re-quote the trading strategy based on the market activity and quoting behavior rule comprises not triggering re-quoting of the trading strategy when the liquidity of the first market does not meet the threshold.

17. An apparatus, comprising:
a trading application configured to receive a definition for a trading strategy having a first leg associated with a first tradeable object and a second leg associated with a second tradeable object, wherein the first and second tradeable objects are listed on an electronic exchange;
a quoting behavior management module configured to:
define a quoting behavior rule for the trading strategy based on at least one of a first liquidity associated with the first leg or a second liquidity associated with the second leg; and
determine whether to re-quote the trading strategy based on market activity and the quoting behavior rule, wherein at least one of the application or the quoting behavior management module is implemented via a processor.

18. The apparatus of claim 17, wherein the quoting behavior management module comprises:
a user-assigned flag module to define the quoting behavior rule by assigning a flag to the first leg according to a user selection;
a market event detection module to monitor a first market associated with the first leg for the market activity; and
a re-quote trigger module to trigger re-quoting of the trading strategy in response to a first event in the first market.

19. The apparatus of claim 18, wherein:
the market event detection module is to not monitor a second market associated with the second leg for the market activity; and
the re-quote trigger is to not trigger re-quoting of the trading strategy in response to a second event in the second market.

20. The apparatus of claim 17, wherein the quoting behavior management module comprises:
a liquidity calculation module to calculate a first current liquidity of a first market associated with the first leg and a second current liquidity of a second market associated with the second leg; and
a dynamic flag module to define the quoting behavior rule by selecting one of the first or second markets according to a relationship between the first and second liquidities;
a market event detection module to monitor the selected one of the first and second markets for the market activity; and
a re-quote trigger to trigger re-quoting of the trading strategy in response to a first event in the selected one of the first and second markets.

21. The apparatus of claim 20, wherein:
the market event detection module is to not monitor an unselected one of the first and second markets; and
the re-quote trigger is to not trigger re-quoting of the trading strategy in response to a second event in the unselected one of the first and second markets.

22. The apparatus of claim 20, wherein selecting one of the first or second markets according to the relationship between the first and second liquidities comprises selecting a least significant one of the first and second liquidities.

23. The apparatus of claim 17, wherein the quoting behavior management module comprises:
a threshold module to define the quoting behavior rule by setting a threshold;
a liquidity calculation module to calculate a liquidity of a first market associated with a market event, the threshold module to compare the liquidity of the first market to the threshold; and
a re-quote trigger to trigger re-quoting of the trading strategy when the liquidity of the first market meets the threshold.

24. The apparatus of claim 23, wherein the re-quote trigger is to not trigger re-quoting of the trading strategy when the liquidity of the first market does not meet the threshold.
